(19) United States
(12) Patent Application Publication
(10) Pub. No.: US 2008/0279986 A1
(43) Pub. Date: Nov. 13, 2008

(54) FOOD PREPARATION IN THE FORM OF A BAR, CONTAINING FUNCTIONAL INGREDIENTS CAPABLE OF PREVENTING DEGENERATIVE PHENOMENA CAUSED BY OXIDIZING AGENTS

(75) Inventors: Pietro De Albertis, Montechiarugolo (Parma) (IT); Camilla Melegari, Parma (IT)

Correspondence Address: AKERMAN SENTERFITT, P.O. BOX 3188, WEST PALM BEACH, FL, 33402-3188, US

(73) Assignee: Barilla G. e R. Fratelli S.p.A., Parma (IT)

(21) Appl. No.: 11/697,474

(22) Filed: Apr. 6, 2007

(30) Foreign Application Priority Data
Apr. 10, 2006 (EP) 06425252.1

(51) Int. Cl. A23L 1/10; A23P 1/08; A23L 1/302

(52) U.S. Cl. 426/72; 426/274

(57) ABSTRACT

A cereal-based food preparation in the form of a bar containing, in percentages by weight based on the total weight of the bar, a quantity of lipids not higher than 18% and a quantity of monosaccharides and disaccharides not higher than 33%, and further containing 0.20-0.40% Vitamin C, 0.10-0.20% Vitamin E and 0.10-0.20% catechins; a regular consumption of such food preparation permits reducing the degenerative phenomena caused by oxidizing agents in the organism; a process is moreover described for the production of the aforesaid food preparation.

### FIELD OF APPLICATION

The present invention generally refers to the field of food and dietary industry.

In particular, the invention concerns a cereal-based food preparation in the form of a ready-to-eat bar, containing functional ingredients capable of exerting a beneficial effect on the health of an individual, preventing degenerative phenomena caused by oxidative agents. The invention moreover regards a process for the production of such food preparation.

### PRIOR ART

It has been known for several decades that the damage which a living organism suffers over time would be due to the accumulation of the so-called free radicals, which carry out a powerful oxidizing action, harmful for nearly all components of the organism.

The free radicals are unstable molecules, which chemically react with any molecular structure they encounter in the organism; they are held responsible for or in any case connected with various diseases, such as for example atherosclerosis, hypertension, ictus, Alzheimer's disease, Parkinson's disease, cataracts, retinitis pigmentosa, arthritis and perhaps also cancer.

The free radicals are formed in the mitochondria, wherein the oxygen is used for producing energy, because oxygen is not entirely consumed but in part, forms these unstable molecules.

The free radical that is produced in greatest quantities is the superoxide anion O₂—, which can react with the hydrogen peroxide and form the dangerous hydroxyl radical OH—. Other radicals which form in the organism are the following: NO—, NO₂₋, O₂+.

The free radicals are continually formed and their production is increased in conditions of stress, exposure to UV (sun) radiation, high calorie diet or in intense physical activity.

In the young organism, free radicals are effectively buffered but, as time goes by, elimination of the free radicals becomes less effective and the organism enters a condition of oxidative stress, and an aggression of various molecules and cellular structures, such as DNA, chromosomes, mitochondria and membranes, by the free radicals takes place.

The polyunsaturated fats and phospholipids are particularly vulnerable to the oxidative stress, which causes for example the conversion of the phosphatidylcholine into lysophosphatidylcholine and oxidizes the apoprotein B100 of the LDLs, making it unrecognizable to the receptors. The oxidated lipoproteins LDLs cause vasoconstriction, increased leucocytes adhesion, and platelet aggregation, which constitutes the initial step of arteriosclerosis.

One aid in the reduction of the free radicals is provided by various molecules of plant origin, such as vitamins, bioflavonoids and pigments. Plants exposed for many hours to the action of air and light have in fact developed defense systems for protecting their DNA, sugars, fats and proteins against oxidation and against free radicals; these include tocopherols, which are found for example in vegetable oils, in green leaves, isoprenes, which are found for example in peppers, apricots and broccoli, anthocyanin pigments, which are found in intense or dark red colored fruit; and polyphenols, which are found in strawberries, onions and citrus fruit.

A regular and abundant consumption of fruits and vegetables can undoubtedly be of benefit in the fight against the free radicals and is indeed recommended by nutritionists. This consumption can be advantageously accompanied by the intake of the abovementioned active substances in the form of dietary preparations (extracts, tablets, capsules etc.) or preferably incorporated in foods which are consumed on a daily basis.

A composition is known, for example from patent EP 1 328 268, for pharmaceutical or dietary use with antioxidant activity, in capsule form, comprising a combination of catechin and quercetin and other active substances, such as for example Vitamin E acetate and Vitamin C.

The U.S. Pat. No. 6,054,128 describes formulations of dietary supplements comprising at least one vitamin chosen from among Vitamin B6, Vitamin B12 and folic acid, selenium, an antioxidant such as e.g. Vitamin C, Vitamin E and beta-carotene, and a bioflavonoid, such as for example rutin, quercetin or catechin. These formulations can be in tablet or capsule form or they can also be incorporated in food bars.

To ensure a constant and continued intake of the above-mentioned anti-free radical active substances, their administration should be included through foods of daily consumption, rather than by means of capsules or tablets. Cereal bars constitute an ideal food carrier for such administration, as they meet the taste of most consumers, can be easily stored and are suited for consumption also outside the home environment, as they are easy to carry.

Nevertheless, the benefits coming from the addition of the above-mentioned active substances—to a bar may be of no avail if attention is not given to the nutritional characteristics of the bar's basic ingredients. In other words, the bar must be nutritionally balanced with respect to its glucid, protein and lipid composition.

### SUMMARY OF THE INVENTION

The problem underlying the present invention was that of making available a cereal-based bar which is nutritionally balanced with respect to its glucid, lipid and protein components, and containing a mixture of active substances suitable for countering the damaging action of free radicals on the organism.

A similar problem was solved, according to the invention, by a food preparation in the form of a bar, which is based on cereals and contains, in percentages by weight based on the total weight of the bar,

a quantity of lipids not higher than 18% and a quantity of monosaccharides and disaccharides not higher than 33%, and which further contains 0.20-0.40% Vitamin C, 0.10-0.20% Vitamin E and 0.10-0.20% catechins.

Preferably, the quantity of Vitamin C is in the range of 0.25-0.30%, the quantity of Vitamin E is in the range of 0.12-0.16% and the quantity of catechins is in the range of 0.13-0.17%.

Vitamin C can be a synthesized ascorbic acid but preferably consists of an ascorbic acid of natural origin and advantageously extracted from a plant extract rich in Vitamin C, such as for example an extract of acerola with 50% Vitamin C.

Vitamin E can consist of d-alpha-tocopherol or its esters, in particular tocopherol acetate, or of mixtures of tocopherols of natural origin.

The catechins preferably consist of green tea extracts.

Advantageously, the food preparation according to the present invention can further contain a natural source of polyphenols, composed of pieces of cocoa beans and/or a natural source of antocyanin pigments, composed of dehydrated cranberries. Both the cocoa beans and the dehydrated cranberries have been shown to synergistically potentiate the anti-free radical activity exerted by the Vitamin C, Vitamin E and catechin mixture.

Moreover, the antocyanins contained in the cranberry (Vaccinium vitis idea) have a documented antitumoral action.

The cocoa beans are very rich in flavonoids (up to 10% by weight), which exert a strong antioxidant effect, in particular if they are combined with the catechins.

The pieces of cocoa bean are contained in the bar according to the invention in a preferred quantity of 3-9%, advantageously 4-7%, by weight based on the total weight of the bar.

The dehydrated cranberry is preferably contained in a quantity which varies from 5 to 15%, advantageously 8-12%, by weight based on the total weight of the bar.

The bar according to the invention is of the so-called “chewy” type, which is obtained by means of mixing operations with the aid of binding agents, rolling and cooling, without oven baking or toasting operations.

The cereals, which represent the basic ingredient of the bar, can be in the form of flakes of various cereals, such as corn, oat, wheat, barley etc., or puffed kernels, such as puffed rice, wheat, barley etc. The cereals preferably constitute 30-50% by weight based on the total weight of the bar.

Various sugary ingredients may be used as binders, such as for example glucose or fructose syrup, honey, sucrose etc.

Preferably, the bar according to the invention is of the “muesli” type and further contains one or more ingredients selected from hazelnuts, almonds, walnuts and similar dried fruits rich in polyunsaturated fatty acids, in a total quantity preferably in the range of 8-16% by weight based on the total weight of the bar.

Other optional ingredients of the bar according to the invention are selected from the following: chocolate, sunflower seeds, sultana raisins and other dehydrated fruits.

It is possible to add a moderate quantity of fats to improve the consistency of the bar and to give it a rounder taste; fats suitable for such a purpose can be selected among cocoa butter, margarine and non-hydrogenated vegetable fats.

The bar according to the present invention is produced by a process which comprises the steps of

a) preparing 55-65 parts by weight of a homogeneous mixture of puffed or flaked cereals and optional additional particulate ingredients;
b) preparing 35-45 parts by weight of a binding fluid mixture based on monosaccharides and disaccharides, kept under stirring under a nitrogen flow, at a temperature of 60-80° C.;
c) rapidly adding to the aforesaid binding fluid mixture, under nitrogen flow and under stirring, Vitamin C, Vitamin E and catechins in quantities such to obtain the following percentages by weight based on the weight of the final binding fluid mixture: 0.45-1.15% Vitamin C, 0.22-0.58% Vitamin E, 0.22-0.58% catechins;
d) mixing the aforesaid homogeneous cereal mixture with said binding fluid mixture, thus obtaining a dough which is subjected to conventional steps of lamination by means of rollers, cooling and finally cutting into bars, which are sent to packaging.

The monosaccharides and disaccharides preferably contained in the aforesaid binding mixture are sucrose and glucose syrup (at different D.E.).

The step of rapid addition of the vitamins and the catechins in step c) preferably lasts no more than 4 minutes and advantageously about 2 minutes, to preserve as much as possible the antioxidant power of the active substances.

### DETAILED DESCRIPTION OF THE INVENTION

The bar according to the present invention will be further described by making reference to two examples provided by way of illustration and not of limitation.

### Example 1

Fruit Bar

| | |
|---|---|
| Puffed rice and puffed wheat | 22.00 |
| Confectioner's sugar | 13.00 |
| Toasted flaked oats | 10.00 |
| Dehydrated cranberries | 10.00 |
| High maltose glucose syrup | 10.00 |
| Split almonds | 7.50 |
| Toasted hazelnut crumbs | 5.50 |
| Glycerol | 5.00 |
| Sultana raisins | 5.00 |
| Malt extract | 3.50 |
| Margarine | 3.00 |
| Sunflower seeds | 4.00 |
| Natural aroma | 0.50 |
| Green tea extract¹ | 0.15 |
| Acerola extract 50% Vitamin C | 0.55 |
| Vitamin E acetate² | 0.30 |

The above reported values are percentages by weight based on the total weight of the final bar.
¹The green tea extract contained 95% epigallocatechin gallate.
²It is a preparation of powdered Vitamin E acetate, supported on SiO₂ and containing 500 I.U. of Vitamin E/g.

The bar was prepared in the following manner

First, the following particulate ingredients were uniformly mixed: puffed rice and puffed wheat, toasted flaked oats, dehydrated cranberries, split almonds, toasted hazelnut crumbs, sultana raisins and sunflower seeds.

A fluid binding mixture was separately prepared, mixing the following ingredients inside a tank at 70° C. for a time of about 5 minutes: confectioner's sugar, high maltose glucose syrup, glycerol, liquid malt extract, margarine, soy lecithin and natural aroma.

The fluid mixture thus obtained was pumped into a second tank, designed for a residence time of no more than 30 minutes and maintained at a constant temperature of to 70° C., subjected to the action of a mechanical agitator in the absence of air and under nitrogen.

Finally, the Teavigo green tea extract, the acerola extract and the Vitamine E acetate (Vitapherole EP-500®) are added and mixed with the fluid mixture for a period of about 2 minutes.

The final fluid mixture is then volumetrically metered always under nitrogen into a continuous mixer, into which the abovementioned homogeneous particulate ingredient mixture also flows in a metered manner.

A homogeneous dough is obtained at the exit of the mixer and is continuously metered on a production line comprising the following steps:
formation of a continuous strand of dough by means of the action of two superimposed calibration rollers;
calibration through an additional pair of rollers;
forming into strips by means of a suitable grooved forming roller;
cooling at a temperature which varies from 5-12° C.;
longitudinal cutting of the strips;
diverging of the strips;
transverse cutting of the strips into bars;
packaging.

### Example 2

Cocoa Bar

| | |
|---|---|
| Chocolate corn flakes | 30.00 |
| Toasted flaked oats | 12.00 |
| Confectioner's sugar | 12.00 |
| High maltose glucose syrup | 12.00 |
| Toasted hazelnut crumbs | 11.00 |
| Cocoa beans in pieces | 6.00 |
| Non-diastased Malt extract | 5.00 |
| Glycerol | 4.00 |
| Margarine | 4.00 |
| Powdered chocolate | 2.00 |
| Soy lecithin powder | 0.80 |
| Chocolate aroma | 0.20 |
| Green tea extract¹ | 0.16 |
| Acerola extract 50% Vitamin C | 0.56 |
| Vitamin E acetate² | 0.28 |

1) and 2): see example 1.

The bar was prepared in an analogous manner to that described for example 1.

The mixture of particulate ingredients comprised chocolate corn flakes, toasted flaked oats and cocoa beans in pieces while the fluid binding mixture comprised confectioner's sugar, high maltose glucose syrup, glycerol, non-diastased malt extract, margarine, soy lecithin, chocolate aroma and powdered chocolate.

The addition of the three active substances to the binding fluid mixture, like all the other operating steps, were conducted under the same conditions described for example 1.

1. Cereal-based food preparation in the form of a bar containing, in percentages by weight based on the total weight of the bar, a quantity of lipids not higher than 18% and a quantity of monosaccharides and disaccharides not higher than 33%, and further containing 0.20-0.40% Vitamin C, 0.10-0.20% Vitamin E and 0.10-0.20% catechins.

2. Food preparation according to claim 1, wherein the quantity of Vitamin C is comprised between 0.25 and 0.30%, the quantity of Vitamin E is comprised between 0.12 and 0.16%, and the quantity of catechins is comprised between 0.13 and 0.17%.

3. Food preparation according to claim 1, further containing cocoa beans in pieces, in a quantity comprised between 3 and 9% by weight based on the total weight of the bar.

4. Food preparation according to claim 1, further containing dehydrated cranberry in a quantity which varies from 5 to 15% by weight based on the total weight of the bar.

5. Food preparation according to claim 3, further containing dehydrated cranberry in a quantity which varies from 5 to 15% by weight based on the total weight of the bar.

6. Food preparation according to claim 1, wherein said Vitamin C is of natural origin.

7. Food preparation according to claim 1, wherein said catechins consist of a purified green tea extract.

8. Food preparation according to claim 1, further containing one or more ingredients selected from hazelnuts, almonds, walnuts and similar dried fruits, in a total quantity comprised between 8 and 16% by weight based on the total weight of the bar.

9. Process for the production of a food preparation in the form of a bar containing, in percentages by weight based on the total weight of the bar, a quantity of lipids not higher than 18% and a quantity of monosaccharides and disaccharides not higher than 33%, and further containing 0.20-0.40% Vitamin C, 0.10-0.20% Vitamin E and 0.10-0.20% catechins, which process comprises the steps of:
a) preparing 55-65 parts by weight of a homogeneous mixture of puffed cereals or cereal flakes and optional additional particulate ingredients;
b) preparing 35-45 parts by weight of a monosaccharide- and disaccharide-based fluid binding mixture based on, with stirring under a nitrogen flow at a temperature of 60-80° C.;
c) rapidly adding to said fluid binding mixture, under nitrogen flow and under stirring, Vitamin C, Vitamin E and catechins in quantities such to obtain the following percentages by weight based on the weight of the final fluid binding mixture: 0.45-1.15% Vitamin C, 0.22-0.58% Vitamin E, 0.22-0.58% catechins;
d) mixing said homogenous cereal mixture with said fluid binding mixture, thus obtaining a dough, which is subjected to conventional steps of lamination by means of rollers, cooling and finally cutting into bars, which are sent on to packaging.

10. Process according to claim 9, wherein said step c) of rapidly adding said vitamins lasts no more than 4 minutes, preferably about 2 minutes.

11. Process for the production of a food preparation in the form of a bar containing, in percentages by weight based on the total weight of the bar, a quantity of lipids not higher than 18%, a quantity of monosaccharides and disaccharides not higher than 33%, and a quantity of dehydrated cranberry of 5 to 15%, and further containing 0.20-0.40% Vitamin C, 0.10-0.20% Vitamin E, 0.10-0.20% catechins, which process comprises the steps of:
a) preparing 55-65 parts by weight of a homogeneous mixture of puffed cereals or cereal flakes and optional additional particulate ingredients;
b) preparing 35-45 parts by weight of a monosaccharide- and disaccharide-based fluid binding mixture based on, with stirring under a nitrogen flow at a temperature of 60-80° C.;
c) rapidly adding to said fluid binding mixture, under nitrogen flow and under stirring, Vitamin C, Vitamin E and catechins in quantities such to obtain the following percentages by weight based on the weight of the final fluid binding mixture: 0.45-1.15% Vitamin C, 0.22-0.58% Vitamin E, 0.22-0.58% catechins;
d) mixing said homogenous cereal mixture with said fluid binding mixture, thus obtaining a dough, which is subjected to conventional steps of lamination by means of rollers, cooling and finally cutting into bars, which are sent on to packaging according to claim 10, wherein said homogeneous mixture of puffed cereals or cereal flakes further contains dehydrated cranberries in a quantity comprised between 7.7 and 27.3% by weight based on the total weight of the mixture.

12. Process for the production of a food preparation in the form of a bar containing, in percentages by weight based on the total weight of the bar, a quantity of lipids not higher than 18%, a quantity of monosaccharides and disaccharides not higher than 33%, and a quantity of cocoa beans in pieces of 3 to 9%, and further containing 0.20-0.40% Vitamin C, 0.10-0.20% Vitamin E, 0.10-0.20% catechins, which process comprises the steps of:
a) preparing 55-65 parts by weight of a homogeneous mixture of puffed cereals or cereal flakes and optional additional particulate ingredients;
b) preparing 35-45 parts by weight of a monosaccharide- and disaccharide-based fluid binding mixture based on, with stirring under a nitrogen flow at a temperature of 60-80° C.;
c) rapidly adding to said fluid binding mixture, under nitrogen flow and under stirring, Vitamin C, Vitamin E and catechins in quantities such to obtain the following percentages by weight based on the weight of the final fluid binding mixture: 0.45-1.15% Vitamin C, 0.22-0.58% Vitamin E, 0.22-0.58% catechins;
d) mixing said homogenous cereal mixture with said fluid binding mixture, thus obtaining a dough, which is subjected to conventional steps of lamination by means of rollers, cooling and finally cutting into bars, which are sent on to packaging according to claim 10, wherein said homogeneous mixture of puffed cereals or cereal flakes further contains cocoa beans in pieces in a quantity comprised between 4.6 and 13.8% by weight based on the total weight of the mixture.
